(19) United States
(12) Patent Application Publication
(10) Pub. No.: US 2026/0151902 A1
(43) Pub. Date: Jun. 4, 2026

(54) APPARATUS AND METHOD FOR PERFORMING ROBOT TASK PLANNING BASED ON LARGE LANGUAGE MODEL

(71) Applicant: ELECTRONICS AND TELECOMMUNICATIONS RESEARCH INSTITUTE, Daejeon (KR)

(72) Inventor: Jae-Woo CHOI, Daejeon (KR)

(21) Appl. No.: 19/379,281

(22) Filed: Nov. 4, 2025

(30) Foreign Application Priority Data
Dec. 4, 2024 (KR) 10-2024-0178183

(51) Int. Cl. B25J 9/16; G05B 13/02; G06F 16/31; G06F 16/3332

(52) U.S. Cl. CPC B25J 9/163; G05B 13/028; G06F 16/322; G06F 16/3338

(57) ABSTRACT

Disclosed herein is an apparatus and method for performing robot task planning based on a large language model. The method may include setting a tree structure in which a natural language goal for the entire task to be performed by a robot is set as an execution node, generating a query corresponding to the natural language goal of the execution node in the tree structure, and selecting and performing, in response to the generated query, either an action (ACT) type for performing a physical action of the robot based on a large language model or an expansion (EXPAND) type for setting subgoals.

### CROSS REFERENCE TO RELATED APPLICATION

This application claims the benefit of Korean Patent Application No. 10-2024-0178183, filed Dec. 4, 2024, which is hereby incorporated by reference in its entirety into this application.

### BACKGROUND OF THE INVENTION

### 1. Technical Field

The disclosed embodiment relates to technology for a robot to plan a series of executable actions by interpreting natural language instructions.

### 2. Description of Related Art

Current technology for planning tasks of a robot commonly uses a method of planning the actions of a robot based on human-designed rules by utilizing a model primarily designed for a specific domain.

However, with the recent development of Large Language Models (LLMs), technologies that generate task plans in general situations by jointly considering natural language instructions and task environments have emerged.

Based on rich semantic knowledge of the world, LLMs may flexibly establish task plans in various situations without being limited to a specific domain. Particularly, LLM-based task planning constructs a prompt from previously performed task planning experiences called in-context examples and uses the same as input. In this way, when a new task is given, a similar task plan may be established.

However, LLM-based task planning has limitations in handling complex tasks. In other words, conventional LLM-based task planning focuses only on predicting a subsequent action, which leads to an attempt to solve complex problems all at once rather than step by step. Accordingly, long input/output processing is required, which may result in performance degradation. Also, as a task is more complex, it is more difficult to provide similar in-context examples.

Therefore, when a complex task involving multiple subgoals is given, it is still difficult to establish accurate task plans.

### SUMMARY OF THE INVENTION

An object of the disclosed embodiment is to establish an accurate task plan based on an LLM when a robot handles a complex task involving multiple subgoals.

Another object of the disclosed embodiment is to assist LLMs in establishing more efficient and precise task plans by utilizing similar task planning experiences.

A method for performing robot task planning based on a large language model according to an embodiment may include setting a tree structure in which a natural language goal for an entire task to be performed by a robot is set as an execution node, generating a query corresponding to the natural language goal of the execution node in the tree structure, and selecting and performing, in response to the generated query, either an action (ACT) type for performing a physical action of the robot based on a large language model or an expansion (EXPAND) type for setting subgoals.

Here, generating the query and selecting and performing either the action (ACT) type or the expansion (EXPAND) type may be repeatedly performed for all execution nodes included in the tree structure.

Here, the method for performing robot task planning based on a large language model according to an embodiment may further include selecting, as an in-context example, an experience having highest similarity to the natural language goal of the execution node from episodic memory, and generating the query may comprise reflecting the in-context example in the query.

Here, selecting and performing either the action (ACT) type or the expansion (EXPAND) type may comprise selecting either the action (ACT) type or the expansion (EXPAND) type based on complexity of a task to be performed by the robot included in the query based on the large language model or probabilities of the action (ACT) type and expansion (EXPAND) type of an in-context example.

Here, selecting and performing either the action (ACT) type or the expansion (EXPAND) type may include selecting and executing a physical action of at least one robot based on the large language model when the action (ACT) type is selected; and updating the tree structure when a task is successfully completed.

The method may further include, when the task is successfully completed, adding an experience of the corresponding task to episodic memory.

Here, generating the query may comprise reflecting, in the query, environment description information generated based on physical actions of the robot performed up to the present and sensor data.

Here, selecting and performing either the action (ACT) type or the expansion (EXPAND) type may further include, when the task is not successfully completed, updating the environment description information based on the physical actions of the robot performed up to present and the sensor data, and after updating the environment description information, operations may be performed again from generating the query.

Here, selecting and performing either the action (ACT) type or the expansion (EXPAND) type may include, when the expansion (EXPAND) type is selected, setting subgoals based on the large language model and updating the tree structure by adding the set subgoals as child nodes.

An apparatus for performing robot task planning based on a large language model according to an embodiment includes memory in which at least one program is recorded and a processor for executing the program, and the program may set a tree structure in which a natural language goal for an entire task to be performed by a robot is set as an execution node, generate a query corresponding to the natural language goal of the execution node in the tree structure, and select and perform, in response to the generated query, either an action (ACT) type for performing a physical action of the robot based on a large language model or an expansion (EXPAND) type for setting subgoals.

Here, for each of all execution nodes included in the tree structure, the program may repeat generating a query corresponding to the natural language goal of the execution node in the tree structure and selecting and performing either the action (ACT) type or the expansion (EXPAND) type in response to the generated query.

Here, the program may select, as an in-context example, an experience having highest similarity to the natural language goal of the execution node from episodic memory, and may reflect the in-context example in the query when generating the query.

Here, when selecting and performing either the action (ACT) type or the expansion (EXPAND) type, the program may select either the action (ACT) type or the expansion (EXPAND) type based on complexity of a task to be performed by the robot included in the query based on the large language model or probabilities of the action (ACT) type and expansion (EXPAND) type of an in-context example.

Here, when selecting and performing either the action (ACT) type or the expansion (EXPAND) type, the program may select and execute a physical action of at least one robot based on the large language model when the action (ACT) type is selected; and may update the tree structure when a task is successfully completed.

Here, when the task is successfully completed, the program may add an experience of the corresponding task to episodic memory.

Here, when generating the query, the program may reflect, in the query, environment description information generated based on physical actions of the robot performed up to the present and sensor data.

Here, when selecting and performing either the action (ACT) type or the expansion (EXPAND) type, if the task is not successfully completed, the program may update the environment description information based on the physical actions of the robot performed up to the present and the sensor data and perform again operations from generating the query.

Here, when selecting and performing either the action (ACT) type or the expansion (EXPAND) type, if the expansion (EXPAND) type is selected, the program may set subgoals based on the large language model and update the tree structure by adding the set subgoals as child nodes.

A method for performing robot task planning based on a large language model according to an embodiment includes setting a tree structure in which a natural language goal for an entire task to be performed by a robot is set as an execution node, selecting, as an in-context example, an experience having highest similarity to the natural language goal of the execution node from episodic memory, generating a query corresponding to at least one of the natural language goal of the execution node in the tree structure, the in-context example, or environment description information generated based on physical actions of the robot performed up to the present and sensor data, or a combination thereof, and selecting and performing, in response to the generated query, either an action (ACT) type for performing a physical action of the robot based on a large language model or an expansion (EXPAND) type for setting subgoals, and generating the query and selecting and performing either the action (ACT) type or the expansion (EXPAND) type may be repeatedly performed for all execution nodes included in the tree structure.

Here, selecting and performing either the action (ACT) type or the expansion (EXPAND) type may comprise selecting either the action (ACT) type or the expansion (EXPAND) type based on complexity of a task to be performed by the robot included in the query based on the large language model or probabilities of the action (ACT) type and expansion (EXPAND) type of the in-context example.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart for explaining a method for performing robot task planning based on a Large Language Model (LLM) according to an embodiment;

FIG. 2 is an exemplary view of hierarchical task planning based on a tree structure according to an embodiment;

FIG. 3 is an exemplary view of a tree structure stored in episodic memory according to an embodiment;

FIG. 4 is an exemplary view of a result of selecting an in-context example according to an embodiment; and

FIG. 5 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

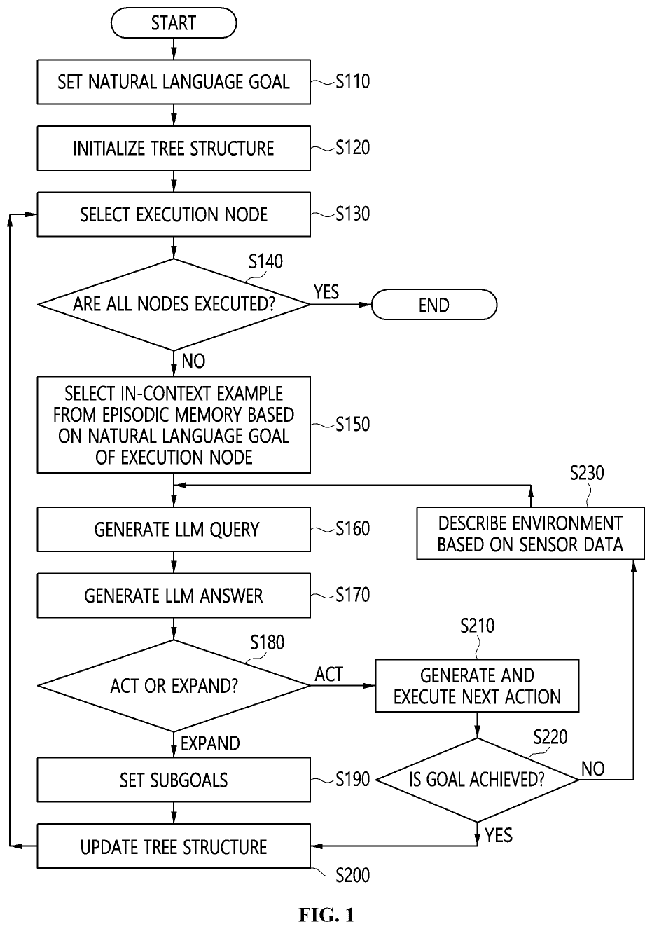

FIG. 1 is a flowchart for explaining a method for performing robot task planning based on an LLM according to an embodiment.

Referring to FIG. 1, the method for performing robot task planning based on an LLM according to an embodiment may include setting a tree structure in which a natural language goal for the entire task to be performed by a robot is set as an execution node at steps S110 to S120, generating a query corresponding to the natural language goal of the execution node in the tree structure at steps S130 to S160, and selecting and performing, in response to the generated query, either an action (ACT) type for performing a physical action of the robot based on a Large Language Model (LLM) or an expansion (EXPAND) type for setting subgoals at steps S170 to S230.

In the method for performing robot task planning based on an LLM according to an embodiment, the entire task performed by the robot may be managed in a tree structure.

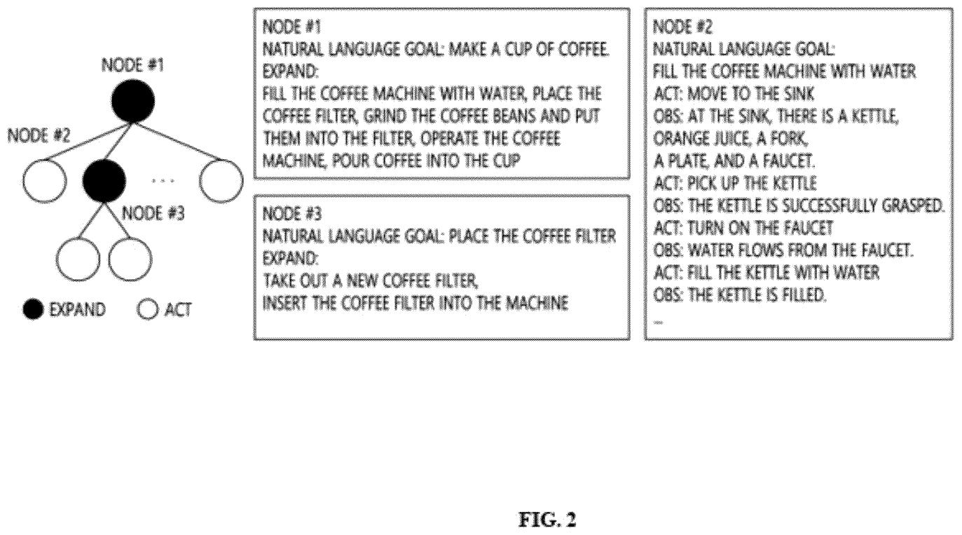

FIG. 2 is an exemplary view of hierarchical task planning based on a tree structure according to an embodiment.

Referring to FIG. 2, each of nodes constituting a tree may have a goal represented in natural language. Then, when each of the nodes is executed, the ACT type is selected to execute the goal at the subsequent step or the EXPAND type is selected to decompose the current goal into subgoals and to expand the node into child nodes at the subsequent step.

Accordingly, when setting the tree structure according to an embodiment at steps S110 to S120, the natural language goal for the entire task to be performed by the robot is set at step S110, and the tree structure such as that illustrated in FIG. 2 is initialized to a single node having the corresponding natural language goal at step S120.

Meanwhile, generating a query according to an embodiment at steps S130 to S160 and selecting and performing either the action (ACT) type or the expansion (EXPAND) type according to an embodiment at steps S170 to S230 may be repeatedly performed for all execution nodes included in the tree structure. That is, after all nodes constituting the tree are executed at step S140, the method for performing robot task planning based on an LLM according to an embodiment may be completed.

When generating a query according to an embodiment at steps S130 to S160, the query to be provided to the LLM may be generated as a prompt.

Here, according to an embodiment, the prompt includes information required for the LLM to determine a subsequent step, and the complexity of the task, current situation information, and a previous successful task planning experience may be reflected therein.

That is, when generating a query at steps S130 to S160, environment description information generated based on the physical actions of the robot performed up to the present and sensor data may be reflected in the query.

That is, the query configured with an in-context example, the natural language goal, and the sensor data-based environment description may be provided to the LLM.

Accordingly, when generating a query according to an embodiment at steps S130 to S150, the experience having the highest similarity to the natural language goal of the execution node may be selected from episodic memory as an in-context example at step S150.

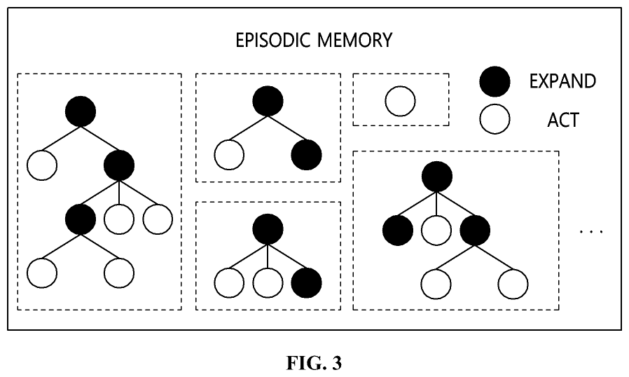

FIG. 3 is an example of a tree structure stored in episodic memory according to an embodiment.

Referring to FIG. 3, episodic memory is stored in a tree structure, and each node may be classified as an ACT node or an EXPAND node. Here, leaf nodes may be classified as ACT nodes, and the other nodes may be classified as EXPAND nodes.

When a new goal is given, an in-context example may be selected from the episodic memory such as that illustrated in FIG. 3 in order to construct the query to be provided to an LLM.

Here, an experience similar to the goal of the node is selected as the in-context example, and this is one of important factors that improve the performance of the LLM. Here, the stored task planning experiences are embedded as vectors through a deep-learning model, and the new goal is also embedded, whereby the most similar K nodes may be selected as in-context examples.

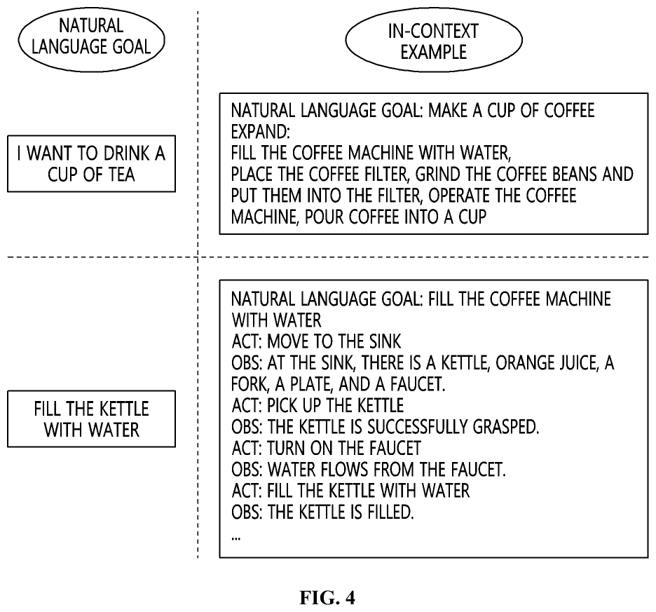

FIG. 4 is an exemplary view of a result of selecting an in-context example according to an embodiment.

Referring to FIG. 4, when a natural language goal such as “I want to drink a cup of tea” is given, a task planning experience for “Make a cup of coffee”, which is the most similar experience, may be selected as an in-context example, and this experience may correspond to an EXPAND node.

Also, when a natural language goal such as “Fill a kettle with water” is given, a task planning experience for “Fill a coffee machine with water”, which is the most similar experience, may be selected as an in-context example, and this experience may correspond to an ACT node.

Referring again to FIG. 1, when selecting and performing either the action (ACT) type or the expansion (EXPAND) type at steps S170 to S230, either the action (ACT) type or the expansion (EXPAND) type may be selected based on the complexity of the task to be performed by the robot included in the query based on the LLM or the probabilities of the action (ACT) type and expansion (EXPAND) type of the in-context example.

In other words, the higher the complexity of the task, the higher the probability of selecting the EXPAND type, and the greater the number of EXPAND types among the selected in-context examples, the higher the probability of selecting the EXPAND type. Conversely, the simpler the task or the greater the number of ACT types among the in-context examples, the higher the probability of selecting the ACT type.

Here, when selecting and performing either the action (ACT) type or the expansion (EXPAND) type at steps S170 to S230, if the expansion (EXPAND) type is selected at step S180, setting subgoals based on the LLM at step S190 and updating the tree structure by adding the set subgoals as child nodes at step S200 may be included.

For example, referring to FIG. 2, when NODE #1, which is a root node, is selected as an expansion (EXPAND) type, a command “Make a cup of coffee” received from a user is expanded and decomposed into subgoals, such as “Fill the coffee machine with water”, “place the coffee filter”, “grind the coffee beans and put them into the filter”, “operate the coffee machine”, and “pour coffee into the cup”.

Here, the generated subgoals become higher-level goals again, and in order to achieve these goals, the process of constructing an initial prompt at step S160 by selecting an in-context example from the episodic memory at step S150 and the process of selecting the subsequent step at steps S170 to S230 are repeated.

The tree expanded as described above may facilitate task decomposition and increase the probability that a similar in-context example is selected from the episodic memory.

Conversely, when selecting and performing either the action (ACT) type or the expansion (EXPAND) type at steps S170 to S230, if the action (ACT) type is selected at step S180, a physical action of at least one robot is selected and executed based on the LLM at step S210.

That is, when the ACT type is selected, the LLM selects an appropriate action from a set of skills executable by the robot and executes the same.

Here, the selected action may be defined as operations that can be physically executed by the robot.

For example, as illustrated in FIG. 2, NODE #2 may sequentially generate and execute actions such as “Pick up the kettle”, “Turn on the faucet”, “Fill the kettle with water”, “Move to the coffee machine”, “Open the water tank”, “Pour water into the water tank”, “Close the water tank”, and the like.

Also, in order to achieve the subgoal such as “Fill the coffee machine with water”, NODE #2 generates “Move to the sink” and executes the same as the subsequent step of the ACT type.

Here, when the task is successfully completed at step S220, updating the tree structure may be performed at step S200.

That is, after the tree structure is updated by marking NODE #2 as execution-completed, the process may proceed to selecting a node to be executed at step S130.

Here, when the task is successfully completed, adding the experience of the corresponding task to the episodic memory may be further performed.

Conversely, when the task is not successfully completed at step S220, updating the environment description information based on the physical actions of the robot performed up to the present and the sensor data may be further performed at step S230.

For example, when the goal “Fill the coffee machine with water” is not achieved, the changed environment is described in natural language based on the sensor data. That is, environment information such as “At the sink, there is a kettle, orange juice, a fork, a plate, and a faucet” may be additionally provided to the LLM as a query.

Accordingly, after updating the environment description information at step S230, the process starting from generating a query at step S160 may be performed again.

The following is an example of a prompt and task planning when a command “I want to drink a cup of green tea” is received from a user.

According to an embodiment, first, the command “I want to drink a cup of green tea” is expanded into “Put a green tea bag into the teacup”, “boil water”, and “pour the boiling water into the teacup”. Then, the subgoals are respectively executed through ACT.

Table 1 below is an example of a result of task planning corresponding to “I want to drink a cup of tea”.

TABLE 1
Prompt
You are an advanced robot with the ability to select between ACT and EXPAND.
You can perform one of the following tasks:

| | |
|---|---|
| 1. | ACT: Execute a specific action to achieve the current goal condition. The list |
| | of available actions is as follows: [Move, Pick up, Put down, Open, Close, |
| | Turn on, Pour] |
| 2. | EXPAND: Decompose the current goal condition into more detailed subgoals. |

In-context Example 1
Goal: Prepare a cup of lemon tea.
OBS: You are now in the kitchen.
EXPAND: Put a lemon tea bag into the cup, boil water, prepare a lemon slice, pour
the boiling water into the cup, put the lemon slice into the cup.
In-context Example 2
Goal: Make a cup of coffee.
OBS: You are now in the living room.
EXPAND: Fill the coffee machine with water, place the coffee filter, grind the coffee
beans and put them into the filter, operate the coffee machine, pour coffee into the
cup.
In-context Example 3
Goal: I want to drink orange juice.
OBS: You are now in the kitchen.
ACT: Move to the refrigerator.
OBS: The refrigerator is closed.
ACT: Open the refrigerator.
OBS: There is cola, orange juice, and water in the refrigerator.
ACT: Pick up the orange juice.
OBS: The orange juice is successfully grasped.
ACT: Move to the table.
OBS: There is a cup, a fork, and a plate on the table.
ACT: Pour orange juice into the cup.
Completed
Task Planning Result
Goal: I want to drink a cup of green tea.
OBS: You are now in the living room.
EXPAND: Put a green tea bag into the teacup, boil water, pour the boiling water into
the teacup.

Table 2 and Table 3 below are examples of a result of task planning corresponding to “Put a tea bag into the teacup”.

TABLE 2
Prompt
You are an advanced robot with the ability to select between ACT and EXPAND.
You can perform one of the following tasks:

| | |
|---|---|
| 1. | ACT: Execute a specific action to achieve the current goal condition. The list |
| | of available actions is as follows: [Move, Pick up, Put down, Open, Close, |
| | Turn on, Pour] |
| 2. | EXPAND: Decompose the current goal condition into more detailed subgoals. |

In-context Example 1
Goal: Put ice in a cup.
OBS: You are now in the kitchen.
ACT: Move to the shelf.
OBS: There are cups, plates, and bowls on the shelf.
ACT: Pick up a cup.
OBS: The cup has been successfully picked up.
ACT: Move to the freezer.
OBS: The refrigerator is closed.
ACT: Open the refrigerator.
OBS: There is orange juice, water, and ice in the refrigerator.
ACT: Pick up the ice.
OBS: The ice has been successfully picked up.
ACT: Put down the ice into the cup.
OBS: The ice has been successfully placed in the cup.
Completed
<Continued in Table 3>

TABLE 3
In-context Example 2
Goal: Put a tomato into the salad bowl.
OBS: You are now in the kitchen.
ACT: Move to the table.
OBS: There is a salad bowl and a tomato on the table.
ACT: Pick up the tomato.
OBS: The tomato has been successfully picked up.
ACT: Put down the tomato into the salad bowl.
OBS: The tomato has been successfully placed into the salad bowl.
Completed
In-context Example 3
Goal: Put bread on a plate.
OBS: You are now in the kitchen.
ACT: Move to the table.
OBS: There is a plate and bread on the table.
ACT: Pick up the bread.
OBS: The bread has been successfully picked up.
ACT: Put down the bread on the plate.
OBS: The bread has been successfully placed on the plate.
Completed
Task Planning Result
Target Goal: Put a green tea bag into a teacup.
OBS: You are now in the living room.
ACT: Move to the drawer.
OBS: The drawer is closed.
ACT: Open the drawer.
OBS: There are green tea bags, lemon tea bags, and black tea bags in the drawer.
ACT: Pick up a green tea bag.
OBS: The green tea bag has been successfully picked up.
ACT: Move to the table.
OBS: There is a teacup on the table.
ACT: Put down the green tea bag into the teacup.
OBS: The green tea bag has been successfully placed into the teacup.
Completed

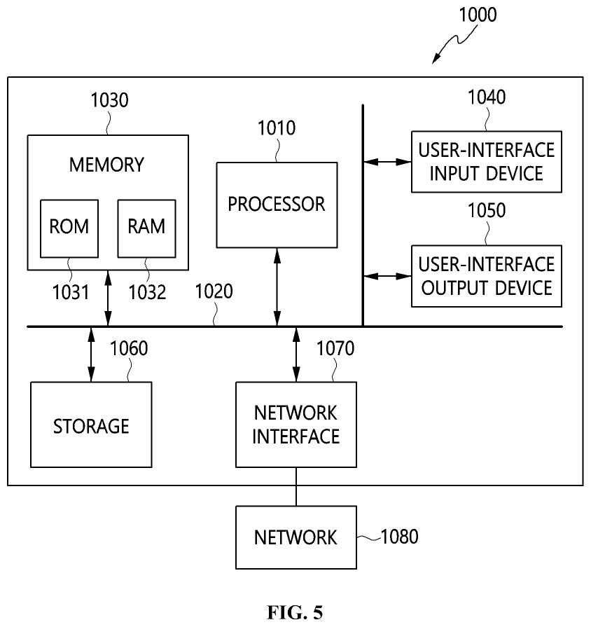

FIG. 5 is a view illustrating a computer system configuration according to an embodiment.

The apparatus for performing robot task planning based on an LLM according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, an accurate task plan may be established based on an LLM when a robot handles a complex task involving multiple subgoals.

According to the disclosed embodiment, LLMs may be assisted in establishing more efficient and precise task plans by utilizing similar task planning experiences.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for performing robot task planning based on a large language model, comprising:
setting a tree structure in which a natural language goal for an entire task to be performed by a robot is set as an execution node;
generating a query corresponding to the natural language goal of the execution node in the tree structure; and
selecting and performing, in response to the generated query, either an action (ACT) type for performing a physical action of the robot based on a large language model or an expansion (EXPAND) type for setting subgoals.

2. The method of claim 1, wherein generating the query and selecting and performing either the action (ACT) type or the expansion (EXPAND) type are repeatedly performed for all execution nodes included in the tree structure.

3. The method of claim 1, further comprising:
selecting, as an in-context example, an experience having highest similarity to the natural language goal of the execution node from episodic memory,
wherein generating the query comprises reflecting the in-context example in the query.

4. The method of claim 1, wherein selecting and performing either the action (ACT) type or the expansion (EXPAND) type comprises selecting either the action (ACT) type or the expansion (EXPAND) type based on complexity of a task to be performed by the robot included in the query based on the large language model or probabilities of the action (ACT) type and expansion (EXPAND) type of an in-context example.

5. The method of claim 1, wherein selecting and performing either the action (ACT) type or the expansion (EXPAND) type comprises
selecting and executing a physical action of at least one robot based on the large language model when the action (ACT) type is selected; and
updating the tree structure when a task is successfully completed.

6. The method of claim 5, further comprising:
when the task is successfully completed, adding an experience of the corresponding task to episodic memory.

7. The method of claim 5, wherein generating the query comprises reflecting, in the query, environment description information generated based on physical actions of the robot performed up to a present and sensor data.

8. The method of claim 7, wherein selecting and performing either the action (ACT) type or the expansion (EXPAND) type further comprises
when the task is not successfully completed, updating the environment description information based on the physical actions of the robot performed up to present and the sensor data, and
after updating the environment description information, operations are performed again from generating the query.

9. The method of claim 1, wherein selecting and performing either the action (ACT) type or the expansion (EXPAND) type comprises
when the expansion (EXPAND) type is selected,
setting subgoals based on the large language model and updating the tree structure by adding the set subgoals as child nodes.

10. An apparatus for performing robot task planning based on a large language model, comprising:
memory in which at least one program is recorded; and
a processor for executing the program,
wherein the program sets a tree structure in which a natural language goal for an entire task to be performed by a robot is set as an execution node, generates a query corresponding to the natural language goal of the execution node in the tree structure, and selects and performs, in response to the generated query, either an action (ACT) type for performing a physical action of the robot based on a large language model or an expansion (EXPAND) type for setting subgoals.

11. The apparatus of claim 10, wherein, for each of all execution nodes included in the tree structure, the program repeats generating the query corresponding to the natural language goal of the execution node in the tree structure and selecting and performing, in response to the generated query, either the action (ACT) type for performing the physical action of the robot based on the large language model or the expansion type (EXPAND) type for setting subgoals.

12. The apparatus of claim 10, wherein the program
selects, as an in-context example, an experience having highest similarity to the natural language goal of the execution node from episodic memory, and
reflects the in-context example in the query when generating the query.

13. The apparatus of claim 10, wherein, when selecting and performing either the action (ACT) type or the expansion (EXPAND) type, the program selects either the action (ACT) type or the expansion (EXPAND) type based on complexity of a task to be performed by the robot included in the query based on the large language model or probabilities of the action (ACT) type and expansion (EXPAND) type of an in-context example.

14. The apparatus of claim 10, wherein, when selecting and performing either the action (ACT) type or the expansion (EXPAND) type, if the action (ACT) type is selected, the program selects and executes a physical action of at least one robot based on the large language model and updates the tree structure when a task is successfully completed.

15. The apparatus of claim 14, wherein, when the task is successfully completed, the program adds an experience of the corresponding task to episodic memory.

16. The apparatus of claim 14, wherein, when generating the query, the program reflects, in the query, environment description information generated based on physical actions of the robot performed up to a present and sensor data.

17. The apparatus of claim 16, wherein, when selecting and performing either the action (ACT) type or the expansion (EXPAND) type, if the task is not successfully completed, the program updates the environment description information based on the physical actions of the robot performed up to the present and the sensor data and then performs again operations from generating the query.

18. The apparatus of claim 10, wherein, when selecting and performing either the action (ACT) type or the expansion (EXPAND) type, if the expansion (EXPAND) type is selected, the program sets subgoals based on the large language model and updates the tree structure by adding the set subgoals as child nodes.

19. A method for performing robot task planning based on a large language model, comprising:
setting a tree structure in which a natural language goal for an entire task to be performed by a robot is set as an execution node;
selecting, as an in-context example, an experience having highest similarity to the natural language goal of the execution node from episodic memory;
generating a query corresponding to at least one of the natural language goal of the execution node in the tree structure, the in-context example, or environment description information generated based on physical actions of the robot performed up to a present and sensor data, or a combination thereof; and
selecting and performing, in response to the generated query, either an action (ACT) type for performing a physical action of the robot based on a large language model or an expansion (EXPAND) type for setting subgoals,
wherein generating the query and selecting and performing either the action (ACT) type or the expansion (EXPAND) type are repeatedly performed for all execution nodes included in the tree structure.

20. The method of claim 19, wherein selecting and performing either the action (ACT) type or the expansion (EXPAND) type comprises selecting either the action (ACT) type or the expansion (EXPAND) type based on complexity of a task to be performed by the robot included in the query based on the large language model or probabilities of the action (ACT) type and expansion (EXPAND) type of the in-context example.
